(19) United States
(12) Patent Application Publication
(10) Pub. No.: US 2013/0078378 A1
(43) Pub. Date: Mar. 28, 2013

(54) COATING APPARATUS AND COATING METHOD

(71) Applicants: Haruhiko Ishihara, Yokohama-shi (JP); Tsuyoshi Sato, Yokohama-shi (JP); Kenichi Ooshiro, Yokohama-shi (JP)

(72) Inventors: Haruhiko Ishihara, Yokohama-shi (JP); Tsuyoshi Sato, Yokohama-shi (JP); Kenichi Ooshiro, Yokohama-shi (JP)

(21) Appl. No.: 13/609,893

(22) Filed: Sep. 11, 2012

(30) Foreign Application Priority Data
Sep. 26, 2011 (JP) 2011-208426

(51) Int. Cl. B05D 3/04; B05C 9/12; B05C 9/10

(52) U.S. Cl. 427/299; 118/58; 427/335

(57) ABSTRACT

According to one embodiment, a coating apparatus includes, a stage which supports an object of coating, and a coating head integrally includes a material discharge unit, which is movable relative to the stage and configured to discharge a coating material to the object of coating on the stage, and a gas injection unit, which, along with the material discharge unit, is movable relative to the stage and configured to inject a gas to the object of coating on the stage.

### CROSS-REFERENCE TO RELATED APPLICATIONS

This application is based upon and claims the benefit of priority from Japanese Patent Application No. 2011-208426, filed Sep. 26, 2011, the entire contents of which are incorporated herein by reference.

### FIELD

Embodiments described herein relate generally to a coating apparatus and a coating method, and more specifically, to a coating apparatus and a coating method in which a coating film is formed by applying a material to an object of coating.

### BACKGROUND

As an example of a method of forming a film on a substrate in the field of semiconductors, there is a coating method in which a material is discharged from a coating nozzle, and the nozzle and substrate, located opposite each other, are moved relatively for coating. In a spiral coating method, a disk-like substrate is fixed on a circular rotating stage, which is rotated with a predetermined distance (gap) between a discharge surface of the nozzle and a surface of the substrate. The material is discharged from the coating nozzle by a constant-volume pump, the flow rate of which is controllable, as the nozzle is moved straight from the center toward the outer periphery of the substrate. In this way, a spiral locus of application is described to form the film on the entire surface of the circular substrate. High-precision control of film thickness and shape is required of the coating apparatus and coating method of this type.

### BRIEF DESCRIPTION OF THE DRAWINGS

FIG. 1 is a schematic explanatory diagram showing a configuration of a coating apparatus according to a first embodiment;

FIG. 2 is an explanatory diagram of a substrate showing a coating method of the first embodiment;

FIG. 3 is an explanatory diagram showing a switching operation for a coating head of the coating apparatus;

FIG. 4 is a flowchart showing the coating apparatus and method of the first embodiment;

FIG. 5 is an explanatory diagram showing regions of the substrate according to the coating method;

FIG. 6 is an explanatory diagram showing the coating apparatus and method of the first embodiment; and

FIG. 7 is an explanatory diagram showing a coating method according to a second embodiment.

### DETAILED DESCRIPTION

In general, according to one embodiment, a coating apparatus comprises a stage and a coating head. The stage supports an object of coating. The coating head integrally comprises a material discharge unit and a gas injection unit.

The material discharge unit is movable relative to the stage and configured to discharge a coating material to the object of coating on the stage. The gas injection unit along is movable relative to the stage with the material discharge unit and configured to inject a gas to the object of coating on the stage.

### First embodiment

A coating apparatus and coating method according to a first embodiment will now be described with reference to FIGS. 1 to 5. In these drawings, arrows X, Y and Z indicate three orthogonal directions. Further, some structural elements are enlarged or reduced in scale or omitted for ease of illustration.

In the present embodiment, the coating apparatus and method will be described as being a spiral coating apparatus and spiral coating method, respectively.

A coating apparatus 1 shown in FIG. 1 comprises a stage 2, rotation mechanism 3, coating head 4, head movement support mechanism 5, and control unit 10. The stage 2 comprises a mounting surface 2a on which a substrate W as an object of coating is placed. The rotation mechanism 3 rotates the stage 2 within a horizontal plane. The coating head 4 moves facing the substrate W. The head movement support mechanism 5 supports the coating head 4 and stage 2 for movement in the directions of X- and Z-axes. The control unit 10 controls these elements.

The stage 2 is, for example, a circular structure that can be rotated within a horizontal plane (XY-plane) about an axis of rotation C2 extending along the Z-axis by the rotation mechanism 3. The stage 2 comprises a suction mechanism that attracts the substrate W placed thereon. The substrate W is fixed and held on the mounting surface 2a of the stage 2 by the suction mechanism. For example, an air suction mechanism or the like may be used as this suction mechanism.

The rotation mechanism 3 is a mechanism that supports the stage 2 for rotation within a horizontal plane and rotates the stage 2 within the horizontal plane about the center of the stage by means of a drive source, such as a motor. Thus, the substrate W on the stage 2 rotates within the horizontal plane.

The coating head 4 integrally comprises a rotating shaft 6, material discharge nozzle 7, vapor injection nozzle 8, and connecting portion 9. The rotating shaft 6 is connected to the head movement support mechanism 5. The material discharge nozzle 7 is disposed on one side of the rotating shaft 6, and the vapor injection nozzle 8 on the other side. The connecting portion 9 connects nozzles 7 and 8.

The material discharge nozzle (material discharge unit) 7 continuously discharges a liquid coating material, such as a resist material, through a nozzle hole 7b at its tip end under pressure and applies the material to the substrate W on the stage 2.

The vapor injection nozzle (gas injection unit) 8 continuously injects a solvent vapor through a nozzle hole 8b at its tip end under pressure and feeds the vapor to the substrate W on the stage 2. The solvent vapor used may be a vapor of a liquid-material solvent, a liquid compatible with the liquid material, or a liquid containing a material having affinity with the liquid material.

The solvent vapor is selected depending on such conditions as the timings for vapor injection and liquid material application. In the case where application of the liquid material is performed immediately after vapor injection, for example, a vapor of a liquid-material solvent, a liquid compatible with the liquid material, or a liquid containing a material having affinity with the liquid material is used.

In the case where vapor injection is performed immediately after application of the liquid material, in contrast, a vapor of a liquid-material solvent or a liquid compatible with the liquid material is used.

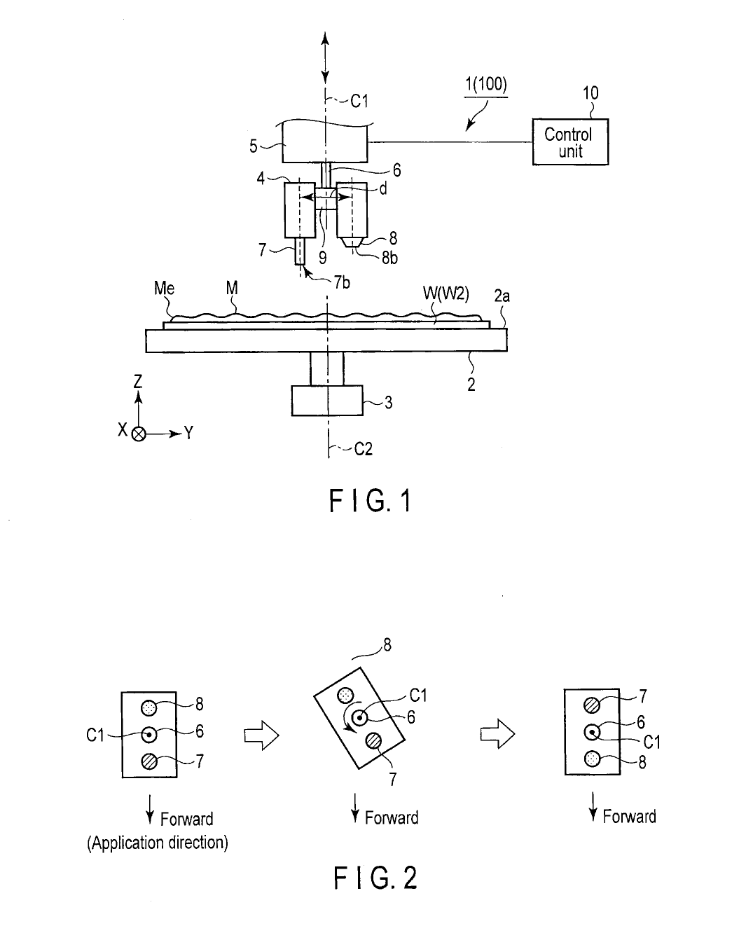

The material discharge nozzle 7 and vapor injection nozzle 8 are integrally disposed with the aid of the connecting portion 9 and are rotatable within the horizontal plane (XY-plane) about the rotating shaft 6 having an axis of rotation C1 extending along the Z-axis. The relative longitudinal positions of nozzles 7 and 8 can be changed as the coating head 4 rotates. Thus, a proper positional relationship can be easily established merely by rotating the coating head 4, as shown in FIG. 2.

Further, the coating head 4 is constructed so that the length of the connecting portion 9 and a distance d between the material discharge nozzle 7 and vapor injection nozzle 8 are adjustable. A time lag between the timings for solvent vapor supply to the substrate W and material application can be adjusted by adjusting the distance d.

As shown in FIG. 1, the movement mechanism 5 comprises a Z-axis movement mechanism, which supports and moves the coating head 4 in the Z-axis direction, and an X-axis movement mechanism, which supports and moves the head 4 in the X-axis direction. The movement mechanism 5 positions the head 4 above the stage 2 and moves the head relative to the stage 2. A linear motor movement mechanism, which uses a linear motor as its drive source, a feed screw movement mechanism, which uses a motor as its drive source, etc., are used for the Z- and X-axis movement mechanisms.

The control unit 10 comprises a microcomputer for intensively controlling the elements and a storage unit that stores various programs and data. A memory, hard disk drive (HDD), etc., may be used as the storage unit.

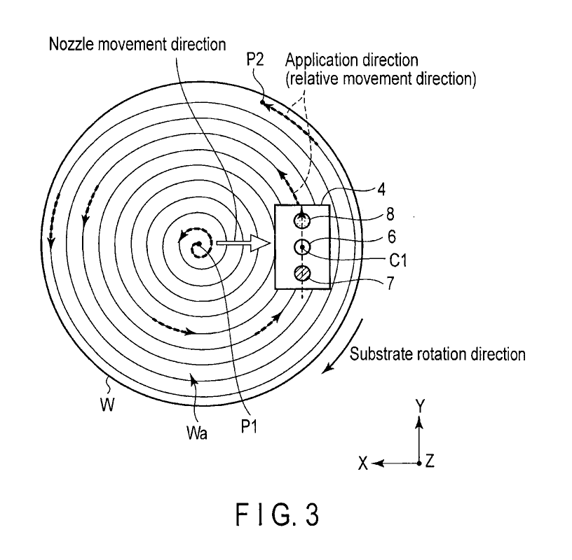

The control unit 10 controls the rotation mechanism 3 and movement mechanism 5 based on the various programs and data (coating condition data, etc.). As shown in FIG. 3, the control unit 10 rotates the stage 2, which carries the substrate W thereon, as liquid material discharge and vapor injection from nozzles 7 and 8 are performed. Then, the control unit 10 linearly moves the coating head 4 in the X-axis direction from the center toward the outer periphery of the substrate W. As a result of the clockwise rotation of the substrate W as in FIG. 3 and the linear movement of the coating head 4 to the right of FIG. 3, the coating head 4 moves relatively in an application direction (relative movement direction) indicated by the arrow in FIG. 3 from a center position P1 toward an outer end portion P2 of the substrate W. Thus, the coating material describes a spiral locus as it is applied to the substrate W (spiral coating), whereupon a film M is formed on the entire surface of the substrate.

Further, the control unit 10 rotates the coating head 4 about the rotating shaft 6 depending on settings, thereby changing the relative application direction of nozzles 7 and 8.

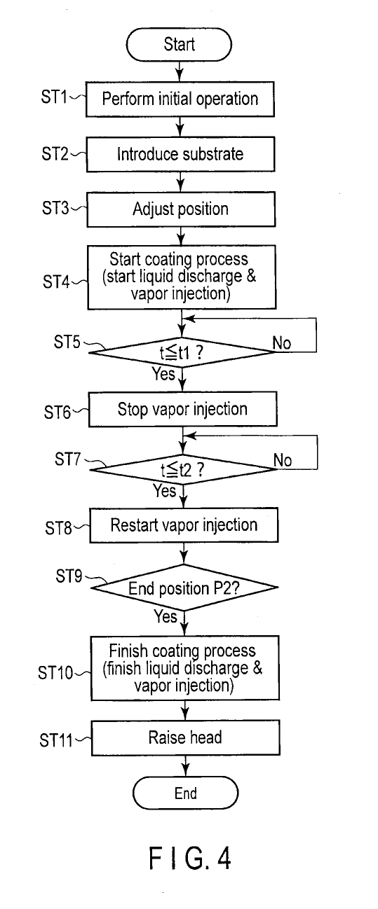

A deposition process (coating method) performed by the coating apparatus 1 will now be described with reference to the flowchart of FIG. 4. The control unit 10 of the coating apparatus 1 performs the deposition process based on the various programs and data (coating condition data, etc.).

As shown in FIG. 4, an initial operation, such as origin return, is performed first (ST1). Then, the substrate W is introduced onto the stage 2 by a transport mechanism, such as a robot handling system (ST2). The substrate W is fixed on the stage 2 by the suction mechanism. Thereafter, the coating head 4 is moved in the Z-axis direction by the Z-axis movement mechanism so that the vertical distance (or gap) between the head 4 and a coated surface of the substrate W is at a set value. Thereupon, the coating head 4 is set in a coating start position on the horizontal plane to be subjected to position adjustment (ST3).

Then, the processing of ST4 to ST10 is performed as a coating process. In the coating process, the coating head 4 is first moved relative to the substrate W as the liquid material is discharged from the material discharge nozzle 7 and the vapor is supplied from the vapor nozzle 8 (ST4).

In the present embodiment, as shown in FIG. 5, vapor injection is locally performed in a center region A1, in which the film thickness increases particularly easily, and an edge region A2, and is not in a central region A3 between regions A1 and A2. In the present embodiment, for example, the coating head 4 to perform processing is moved from the coating start position P1 in the center toward the coating end position P2 at the outer peripheral end. Accordingly, vapor injection is performed along with liquid material discharge until a certain time has elapsed since the start of coating under the control of the control unit 10 (ST5), and the vapor injection is stopped after time t1 has elapsed (ST6). Thereafter, only the liquid material discharge is performed (ST7), the vapor injection is restarted after a certain time t2 has elapsed (ST8), and the vapor injection is continued along with the liquid material discharge until the end of coating. For example, times t1 and t2 are set according to such conditions as the coating speed, the widths of regions A1 and A2, etc.

As the stage 2 is rotated by the rotation mechanism 3 so that the substrate W thereon rotates, the coating head 4 moves at a constant speed in the X-axis direction from the start position in the center of the substrate W, that is, from the center toward the outer periphery of the substrate. Then, the vapor is injected from the vapor injection nozzle 8 and the liquid material is continuously discharged from the material discharge nozzle 7 onto the coated surface of the substrate W, whereby the material is spirally applied to the coated surface (spiral coating). Thus, the coating film M is formed on the coated surface of the substrate W.

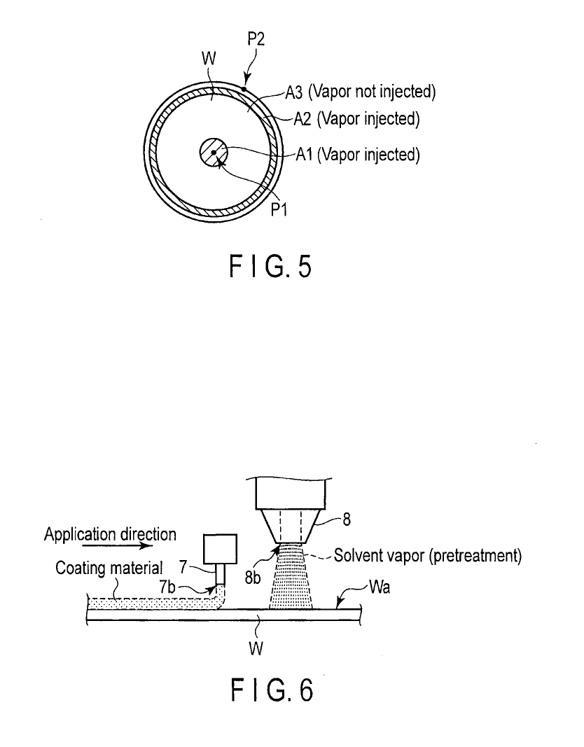

As the coating head 4 moves in this manner, the vapor is first injected from nozzle 8, which is located forward relative to the application direction, as pretreatment in regions A1 and A2, as shown in FIG. 6. Immediately after this, the liquid material is discharged from nozzle 7.

The liquid material discharge and vapor injection from nozzles 7 and 8 are continuously performed in this arrangement. Since nozzles 7 and 8 are longitudinally staggered in the application direction, however, the vapor injection and liquid application on the substrate W are sequentially performed at several parts of the spiral locus of application from the start position P1 to the end position P2.

Then, it is determined whether or not a preset predetermined position or time has been reached (ST9). If it is determined that the predetermined position or time immediately before completion of coating has not been reached (NO in ST9), the coating process is continued. In the case of a circular substrate W, the outer end portion is assumed to be in the end position P2. When the end position P2 is reached, the liquid discharge and vapor injection are finished, whereupon the coating process ends (ST10).

After the end of the coating, the coating head 4 is raised by the movement mechanism 5 (ST11). Then, the coating film M on the substrate W is observed or checked by means of an observation device to see if it is subject to pinholes or monitor the presence of extraneous matter in the coating film M, the appearance of abnormal film thickness, the shape of an edge portion of the coating film M, etc. If necessary, a repair process is performed for partial coating, whereupon the processing ends.

According to the coating apparatus and method of the present embodiment, the film thickness can be controlled such that the viscosity and wettability of the coating liquid are changed by injecting the solvent vapor during a coating operation.

If a vapor of a liquid having affinity or compatibility is pre-injected immediately before coating material discharge, for example, the wettability of the liquid on the substrate is improved, so that the liquid material applied immediately thereafter spreads easily. Thus, the film thickness becomes uniform, so that the homogeneity of the entire substrate W is improved.

According to the present embodiment, moreover, the injection can be locally performed by locally controlling the timing for the solvent vapor injection. Therefore, the film thickness can be controlled to be uniform by locally performing vapor injection in the center position at the coating start point where the film thickness is liable to increase under the influence of the centrifugal force of the rotation of the substrate, the force of inertia of a constant-volume pump, etc., and the edge portion at the coating end point, in particular. Thus, a problem can be avoided that may be caused in a subsequent exposure/development process if the film thickness increases locally.

In the coating apparatus and method of the present embodiment, the vapor injection nozzle and material discharge nozzle are integrally moved as the material application and solvent vapor injection are performed, so that the difference in timing can be reduced, and the timing control can be facilitated. Thus, processing can be achieved before volatilization or degeneration is caused by drying. Further, a very small amount of solvent can be uniformly introduced onto the surface of the substrate or the applied liquid by supplying the vapor.

The relative longitudinal positions of nozzles 7 and 8 can be changed by arranging the nozzles individually on the opposite sides of the rotating shaft and rotating the coating head 4 to change its angle. Thus, the timing for solvent supply can be changed with a simple structure according to the material and environment.

Since the vapor injection can be performed along with the liquid application, the processing time can be reduced. Further, local processing can be achieved by controlling the timing for the vapor injection.

The present invention is not limited to the embodiment described above. According to the first embodiment, for example, the vapor injection nozzle 8 is located before the material discharge nozzle 7 in the application direction, and the vapor injection is performed before the material application. Alternatively, however, the processing can be achieved in the reverse order by rotating the coating head 4 to change the relative longitudinal positions, as shown in FIG. 4, for example. If the vapor of the compatible liquid is injected immediately after the coating material discharge, the viscosity of the coating material is reduced, so that the liquid material spreads easily. Thus, the film thickness becomes uniform, so that the uniformity of the entire substrate W is improved.

In connection with the embodiment described above, the film thickness is assumed to be controlled by locally performing vapor injection at the coating start and end points where the film thickness and shape easily vary. Alternatively, however, other regions may be locally subjected to vapor injection, or the entire surface of the substrate W may be uniformly subjected to vapor injection. Further, the vapor injection quantity may be made adjustable so that it can be controlled in a plurality of steps depending on the regions to be coated.

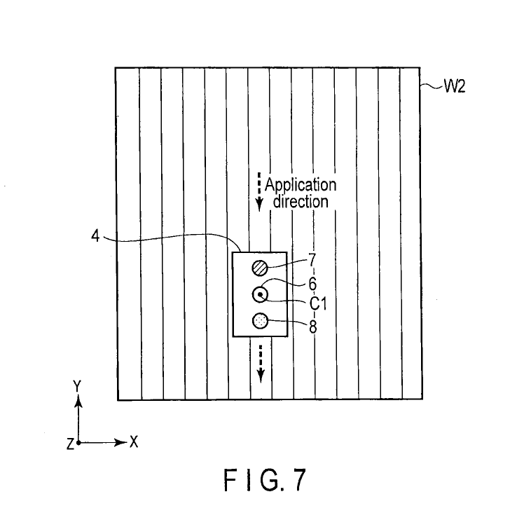

Although the material is spirally applied to the circular substrate W in the spiral coating apparatus and spiral coating method according to the first embodiment described above, the present invention is not limited to this embodiment. As in a coating apparatus 100 and coating method according to another embodiment, as shown in FIGS. 1 and 7, a coating head may be moved in a straight line relative to a rectangular substrate W2 as material discharge and vapor injection are performed, for example. In this case, material application and vapor injection are achieved based on relative movement along a locus on the straight line.

In the coating apparatus 100 shown in FIG. 1, nozzles 7 and 8 are arranged in parallel in the application direction, and the coating head 4 is enabled to move in the X- and Y-axis directions. Thus, the coating head 4 can be moved relatively along the locus on the straight line of the present embodiment, thereby achieving a coating process for the substrate W2.

This embodiment provides the same effect as that of the first embodiment. Specifically, the coating head 4 integrally comprises the material discharge nozzle 7 and vapor injection nozzle 8 such that nozzles 7 and 8 are integrally movable. Accordingly, vapor injection and material application for the substrate W2 can be sequentially performed. Further, the relative longitudinal positions can be changed by rotation, and the distance d between nozzles 7 and 8 is adjustable, so that the processing order and interval can be adjusted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coating apparatus comprising:
a stage which supports an object of coating; and
a coating head integrally comprising a material discharge unit, which is movable relative to the stage and configured to discharge a coating material to the object of coating on the stage, and a gas injection unit, which, along with the material discharge unit, is movable relative to the stage and configured to inject a gas to the object of coating on the stage.

2. The coating apparatus of claim 1, wherein the coating head is configured to be rotatable about an axis of rotation perpendicular to a surface of the stage, and longitudinal positions of the material discharge unit and the gas injection unit are changeable by the rotation.

3. A coating method comprising:
discharging a coating material from a material discharge unit attached to a coating head while moving the coating head relative to an object of coating; and
supplying a gas from a gas injection unit attached to the coating head.

4. The coating method of claim 3, wherein the gas injection and the material discharge to the object of coating are sequentially performed as the coating head moves relatively with the gas injection unit located before the material discharge unit in an application direction, and the gas is a vapor of a solvent of the coating material, a liquid compatible with the coating material, or a liquid containing a material having affinity with the coating material.

5. The coating method of claim 3, wherein the material discharge and the gas injection to the object of coating are sequentially performed as the coating head moves relatively with the gas injection unit located behind the material discharge unit in an application direction, and the gas is a vapor of a solvent of the coating material or of a liquid compatible with the coating material.
